(19) United States
(12) Patent Application Publication
(10) Pub. No.: US 2024/0390899 A1
(43) Pub. Date: Nov. 28, 2024

(54) BIOCHIP AND CONNECTOR MODULE

(71) Applicant: Radiant Opto-Electronics Corporation, KAOHSIUNG (TW)

(72) Inventors: Yi-Jen CHIU, KAOHSIUNG (TW); Sung-Fu WU, KAOHSIUNG (TW); Hui-Hua HUNG, KAOHSIUNG (TW)

(73) Assignee: Radiant Opto-Electronics Corporation, KAOHSIUNG (TW)

(21) Appl. No.: 18/635,505

(22) Filed: Apr. 15, 2024

(30) Foreign Application Priority Data
May 26, 2023 (CN) 202310611014.6

(51) Int. Cl. B01L 3/00

(52) U.S. Cl. CPC B01L 3/50273; B01L 2200/027; B01L 2200/0621; B01L 2300/0819; B01L 2300/0877; B01L 2300/123; B01L 2400/0487; B01L 2400/086

(57) ABSTRACT

A biochip includes a chip unit and an elastic pad. The chip unit comprises a plurality of liquid inlets arranged at intervals, and a plurality of micro flow channels respectively communicating with the liquid inlets. The elastic pad has an upper surface and a lower surface, and the lower surface is pasted on the chip unit. The elastic pad includes a plurality of guide channels arranged at intervals and penetrating the upper surface and the lower surface of the elastic pad. The guide channels respectively correspond to the liquid inlets of the chip unit. Each guide channel has an upper guiding section, and the diameter of the upper guiding section is gradually reduced from top to bottom. The detection liquid can enter the chip unit more quickly through the guide channel and improving the detection efficiency and accuracy. The invention also provides a connector module used in conjunction with the biochip.

### RELATED APPLICATIONS

This application claims priority to China Application Number 202310611014.6, filed on May 26, 2023. The entire disclosures of all the above applications are hereby incorporated by reference.

### FIELD OF THE INVENTION

The present invention relates to a biochip and connector module, particularly a biochip and connector module can avoid leakage and control the minute amount of micro-injection liquid.

### BACKGROUND OF THE INVENTION

Biochips are designed using the principles of microelectronics, microfluidics, molecular biology, biotechnology, genetic testing, analytical chemistry, etc., and use silicon wafers, glass, or polymers as base materials, and cooperate with micro-electromechanical automation, or other high-tech components made by precision processing technology, with fast, accurate, and low-cost biological analysis and testing capabilities.

Biochips need to be used in conjunction with a liquid injection system and a photography system. Both the liquid injection system and the photography system are set up vertically in conventional equipment. The above configuration may increase the size of the overall experimental system and require more precise configuration and alignment design to avoid interference between the liquid injection system and the photography system.

In addition, since the liquid injection system and the biochip have their own moving directions, they need to be aligned using a dynamic assembly method, and the accuracy needs to be extremely high to avoid leakage of the liquid. Moreover, when the liquid injection system injects the liquid to be detected into the biochip, how to control the infusion in minute amounts and allow the liquid to be detected to enter the biochip completely and quickly to improve detection efficiency and accuracy is also a major topic in this field.

### SUMMARY OF THE INVENTION

One object of the present invention is to provide a biochip that can accurately control the amount of microinjection and has a better configuration guiding effect.

The biochip comprises a chip unit and an elastic pad disposed on the chip unit. The chip unit includes a plurality of liquid inlets arranged at intervals, and a plurality of microfluidic channels respectively connected to the liquid inlets. The elastic pad includes an upper surface and a lower surface, and the lower surface is attached to the chip unit. The elastic pad further includes a plurality of guide channels arranged at intervals and penetrating the upper surface and the lower surface of the elastic pad. The guide channels respectively correspond to the liquid inlets of the chip unit. Each of the guide channels includes an upper guide section, and the diameter of the upper guide section is gradually reduced from top to bottom.

In a preferable embodiment, each of the guide channels further includes a lower guide section connected to the upper guide section, and the diameter of the lower guide section gradually increases from top to bottom.

In a preferable embodiment, the lower guide section of each of the guide channels corresponds to one of the liquid inlets of the chip unit, and the diameter of the outlet of the lower guide section is larger than the diameter of the liquid inlet of the chip unit.

In a preferable embodiment, the elastic pad further includes a pad body and a plurality of connection openings protruding from the pad body at intervals. The upper guide section of each of the guide channels extends from the connection opening toward the pad body, and the lower guide section of each of the guide channels is in the pad body.

In a preferable embodiment, the upper guide section and the lower guide section of each of the guide channels are connected by a pressurized section, and the diameter of the pressurized section is less than or equal to the minimum diameter of the lower guide section.

Another object of the present invention is to provide a connector module that can be used in conjunction with the biochip. The connector module can avoid leakage and accommodate alignment tolerances to achieve high throughput detection of biochips.

The connector module comprises a fixed unit and an infusion unit. The fixed unit includes a plurality of liquid outlet joints arranged at intervals, and the liquid outlet joints are respectively connected with the upper guide sections of the guide channels of the elastic pad. The infusion unit includes a plurality of infusion tubes respectively connected to the liquid outlet joints.

In a preferable embodiment, each of the liquid outlet joint protrudes from the bottom surface of the fixed unit. The fixed unit further includes a plurality of flow channels. Each of the flow channels includes a vertical section, each of the vertical sections extends into the corresponding liquid outlet joint, and the infusion tubes of the infusion unit are respectively connected with the flow channels.

In a preferable embodiment, each of the liquid outlet joint protrudes from the bottom surface of the fixed unit. The fixed unit further includes a plurality of flow channels. Each of the flow channels includes a vertical section and a horizontal section connected to the vertical section, each of the vertical sections extends into the corresponding liquid outlet joint, and the infusion tubes of the infusion unit are respectively accommodated in corresponding horizontal sections and are respectively connected with the flow channels.

In a preferable embodiment, the fixed unit further includes an upper fixed plate and a lower fixed plate. The upper surface of the lower fixed plate forms the flow channels, and the infusion tubes are clamped and positioned between the upper fixed plate and the lower fixed plate.

In a preferable embodiment, each of the flow channels further includes a positioning section connected to the horizontal section, and the width of the positioning section is greater than the width of the horizontal section. The infusion unit further includes a plurality of positioning members respectively accommodated in the positioning sections, and the infusion tubes are respectively clamped and positioned on corresponding positioning members and stretched into corresponding horizontal sections.

In a preferable embodiment, the outer contour of each of the liquid outlet joints of the fixed unit matches the inner contour of the upper guide section of each of the guide channels.

The characteristic of the present invention is that through the tapered section of the guide channel of the biochip, the injection amount can be accurately and minutely pushed. The present invention also provides a connector module, in which the contour of the liquid outlet joints of the connector module matches the guide channels of the elastic pad of the biochip. The invention uses the elastic pad to connect with the liquid outlet joint, which can not only avoid liquid leakage, but also accommodate a larger alignment tolerance, so as to solve the docking problem of movable parts during the dynamic liquid injection process, and to reduce the demand for alignment precision between movable parts. When the detection liquid enters the guide channel, it can enter the chip unit more quickly to improve detection efficiency and accuracy, and to achieve high-throughput detection of biochip.

### BRIEF DESCRIPTION OF THE DRAWINGS

FIG. 1 is a three-dimensional exploded perspective diagram according to a preferred embodiment of a biochip and connector module of this invention.

FIG. 2 is a partial side exploded diagram to assist in explaining FIG. 1.

FIG. 3 is a partial side cross-sectional diagram illustrating the structure of a guide channel of an elastic pad.

FIG. 4 is a partial side cross-sectional diagram illustrating another embodiment of the guide channel.

### DETAILED DESCRIPTION OF THE INVENTION

The detailed description and preferred embodiments of the invention will be set forth in the following content and provided for people skilled in the art to understand the characteristics of the invention. In addition, the directional terms mentioned in the following embodiments, such as up, down, left, right, front, back, bottom, top, etc., are only for reference to the directions in the attached drawings. Therefore, the directional terms used are illustrative rather than limiting.

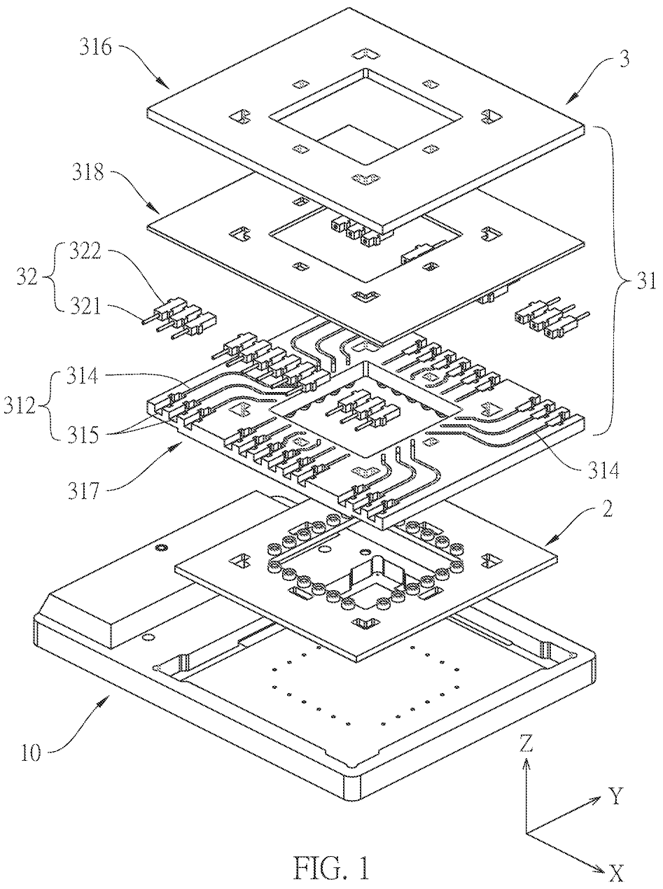

Referring to FIG. 1, it is a preferred embodiment of the biochip 2 and connector module 3 of the present invention. It should be noted that the biochip 2 is placed on a stage 10 and then combined with the connector module 3. In one embodiment, the stage 10 can move along an XY plane, which is beneficial to the placement and photography of the biochip 2. The moving mechanism of the stage 10 is not the focus of this invention and will not be described in detail.

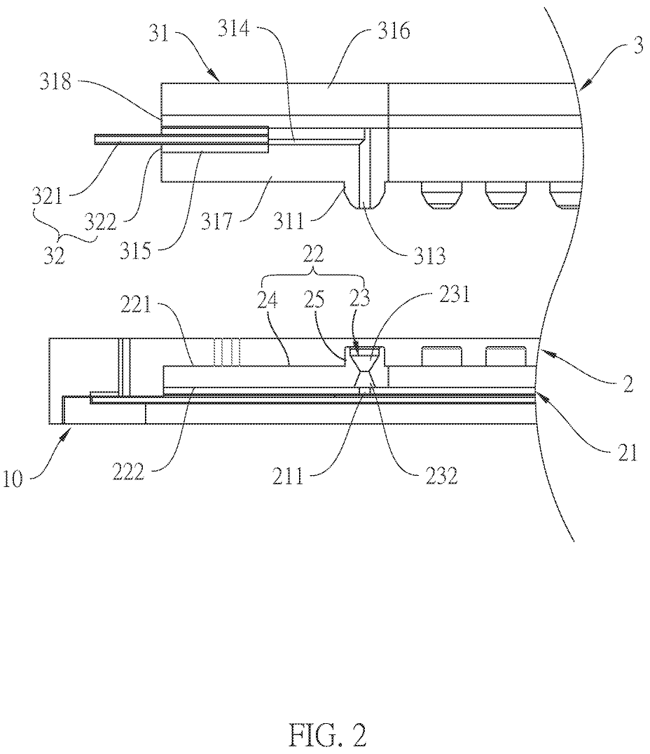

Referring to FIG. 2, the biochip 2 includes a chip unit 21 and an elastic pad 22 disposed on the chip unit 21. The chip unit 21 has a plurality of liquid inlets 211 arranged at intervals and a plurality of micro-channels (not shown) connected to the liquid inlets 211 respectively. Since the structure of the micro-channels in the chip unit 21 can be understood by those with ordinary skill in the art and is not the focus of this invention, it is not shown in the figure and will not be described in detail. The elastic pad 22 has an upper surface 221 and a lower surface 222, and the lower surface 222 is attached to the chip unit 21. The elastic pad 22 includes a plurality of guide channels 23 arranged at intervals and penetrating the upper surface 221 and the lower surface 222 of the elastic pad 22. The guide channels 23 respectively correspond to the liquid inlets 211 of the chip unit 21. Each of the guide channels 23 has an upper guide section 231, and the diameter of the upper guide section 231 is gradually reduced from top to bottom. The guide channel 23 in the biochip 2 of the present invention includes the tapered upper guide section 231, which can achieve the effect of accurately controlling the micro-injection amount when pushing liquid in conjunction with the liquid injection device.

The connector module 3 of the present invention is used in conjunction with the biochip 2. The connector module 3 includes a fixed unit 31 and an infusion unit 32. The fixed unit 31 includes a plurality of liquid outlet joints 311 arranged at intervals. The liquid outlet joints 311 are respectively connected to the upper guide sections 231 of the guide channels 23 of the elastic pad 22. The infusion unit 32 includes a plurality of infusion tubes 321 that are respectively connected with the liquid outlet joints 311. The connector module 3 can be moved along the Z direction, and the biochip 2 is placed on the stage 10 and moved along the XY direction. Therefore, the biochip 2 and the connector module 3 can align with each other in the XYZ direction. As the liquid outlet joints 311 of the connector module 3 are respectively connected to the upper guide sections 231 of the guide channels 23 of the elastic pad 22, it can not only avoid liquid leakage, but also possess a larger alignment tolerance, solve the docking problem of movable parts during the dynamic liquid injection process, and reduce the need for alignment precision between movable parts. When the detection liquid enters the guide channel 23, it can enter the chip unit 21 more quickly to improve detection efficiency and accuracy, and to achieve high-throughput detection of biochip 2.

Referring to FIG. 2, the elastic pad 22 includes a pad body 24 and a plurality of connection openings 25 protruding from the pad body 24 at intervals. In more detail, each of the guide channels 23 further includes a lower guide section 232 connected to the upper guide section 231, and the diameter of the lower guide section 232 gradually increases from top to bottom. The upper guide section 231 extends from the connection opening 25 toward the pad body 24, and the lower guide section 232 is in the pad body 24. The protruding design of the upper guide section 231 can achieve the effect of easy docking and possess a larger docking tolerance. The lower guide section 232 of each of the guide channels 23 corresponds to one of the liquid inlets 211 of the chip unit 21, and the diameter of the outlet of the lower guide section 232 is larger than the diameter of the liquid inlet 211 of the chip unit 21. Thereby, the outlet of the guide channel 23 can completely cover the corresponding liquid inlet 211, achieving the effect of easily assembling and connecting the outlet of the lower guide section 232 and the liquid inlet 211. Even better, the guide channel 23 of this embodiment is part of the elastic pad 22. When the liquid outlet joints 311 move along the Z direction toward the guide channels 23 of the biochip 2 and is connected, the elasticity of the elastic pad 22 can prevent the detection liquid from leaking out.

Referring to FIG. 1 and FIG. 2, in some embodiments, the liquid outlet joints 311 of the connector module 3 protrude from the bottom surface of the fixed unit 31. The fixed unit 31 further comprises a plurality of flow channels 312, each of the flow channels 312 comprises a vertical section 313. Each of the vertical sections 313 extends into the corresponding liquid outlet joint 311. The infusion tubes 321 of the infusion unit 32 are respectively connected with the flow channels 312. The assembly direction of the infusion tubes 321 is perpendicular to the joining direction of the elastic pad 22 and the connector module 3, which is beneficial to reducing the overall equipment size.

In another embodiment, in addition to the vertical section 313, the fixed unit 31 further comprises a horizontal section 314 connected to the vertical section 313. The infusion tubes 321 of the infusion unit 32 are arranged laterally and are respectively accommodated in the corresponding horizontal sections 314 and communicate with the flow channels 312 respectively. For example, the photography system is usually located relatively above the connector module 3, that is, the shooting direction of the photography system is perpendicular to the extension direction of the infusion tubes 321. Therefore, the lateral arrangement of the infusion tubes 321 can avoid affecting the shooting field of the photography system, which is beneficial to increase the camera's shooting range and the microfluidic channel imaging results of the biochip 2. In the present invention, the conventional injection module of the prior art that can only inject liquid in the vertical direction is replaced with the connector module 3 that includes both vertical and horizontal directions. Therefore, it is not only for changing the liquid flow direction, but also greatly saving the space occupied by the liquid injection system.

In some embodiments, in addition to the vertical section 313 and the horizontal section 314, the fixed unit 31 further comprises a positioning section 315 connected to the horizontal section 314. The width of the positioning section 315 is greater than the width of the horizontal section 314. The infusion unit 32 further comprises a plurality of positioning members 322 respectively accommodated in the positioning sections 315. The infusion tubes 321 are respectively clamped and positioned on the corresponding positioning members 322 and extend into the corresponding horizontal sections 314.

The fixed unit 31 further comprises an upper fixed plate 316 and a lower fixed plate 317. The flow channels 312 are formed on the top surface of the lower fixed plate 317. The infusion tubes 321 are clamped and positioned between the upper fixed plate 316 and the lower fixed plate 317. It should be noted that in this embodiment, the flow channels 312 are directly recessed on the top surface of the lower fixed plate 317. Therefore, the fixed unit 31 further includes a blocking piece 318 disposed on the lower fixed plate 317 to cover the flow channels 312. The blocking piece 318 is clamped between the upper fixed plate 316 and the lower fixed plate 317 to block the flow channels 312 to achieve a leakage-proof effect. If the upper fixed plate 316 is made of a material that has the effect of blocking liquid, or the flow channels 312 are formed inside the lower fixed plate 317, the blocking piece 318 can be omitted.

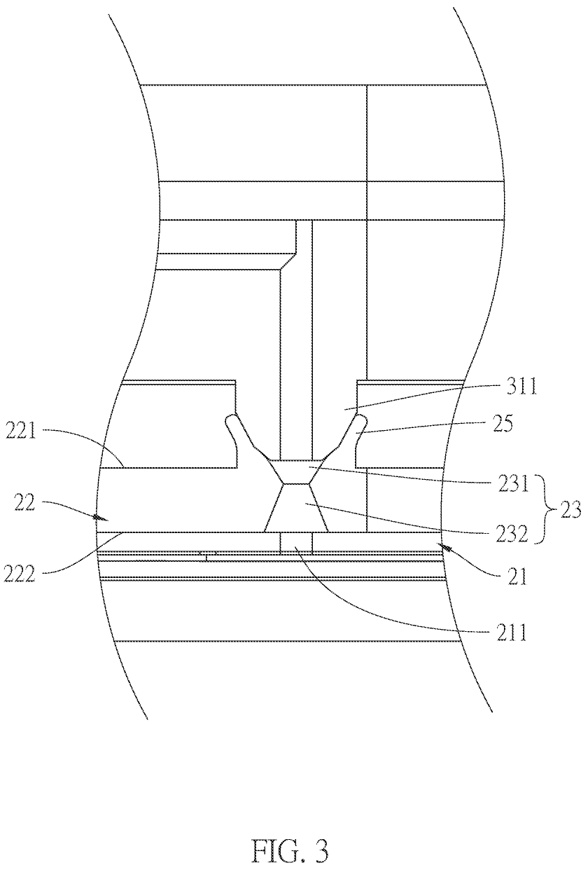

In the present invention, the connector module 3 is connected to the biochip 2 for use. Since the outer contour of each liquid outlet joint 311 of the fixed unit 31 matches the inner contour of the upper guide section 231 of the guide channel 23, and the connection opening 25 of the elastic pad 22 is elastic, therefore, as shown in FIG. 3, when the liquid outlet joint 311 is docked with the corresponding connection opening 25, the front end of the liquid outlet joint 311 can be completely covered by the corresponding connection opening 25, and the connection opening 25 and the upper guide section 231 will be slightly stretched to achieve a good covering effect.

Referring to FIG. 1 and FIG. 3, after the docking is completed, the liquid to be detected will enter the flow channel 312 through the infusion tube 321, flow through the horizontal section 314 and the vertical section 313, and finally enter the guide channel 23. The diameter of the upper guide section 231 of the guide channel 23 is tapered from top to bottom into a funnel shape, which can quickly guide the liquid to be detected to flow downward into the lower guide section 232. Then, the liquid to be detected enters the microfluidic channel from the lower guide section 232 through the liquid inlet 211 of the chip unit 21 for detection. The diameter of the lower guide section 232 gradually increases from top to bottom, forming a liquid storage cavity, so that the liquid to be detected that has not yet entered the liquid inlet 211 can briefly stay in the lower guide section 232 to avoid upward overflow.

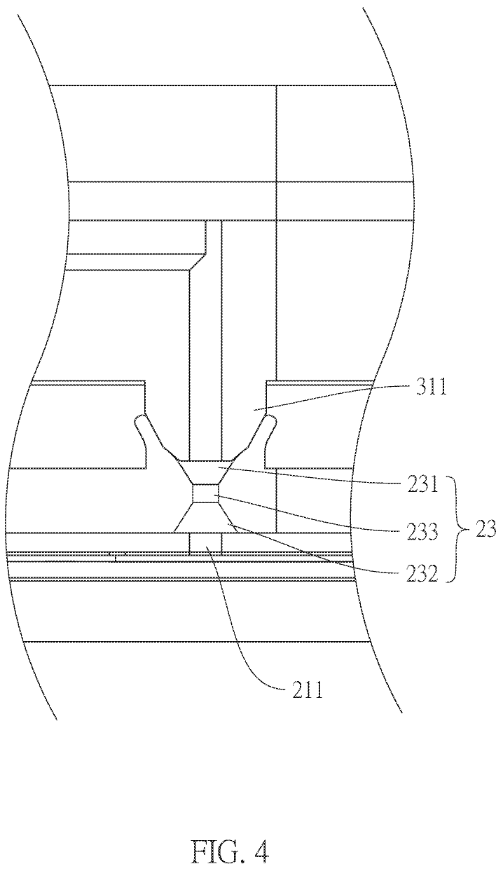

The biochip 2 forms a design with a wider upper and lower opening and a narrower middle section through the diameter changes of the upper guide section 231 and the lower guide section 232 of each guide channel 23. It is helpful for the biochip 2 to align with the liquid outlet joint 311 upward and for the guide channel 23 align with the liquid inlet 211 downward. Besides, the narrow middle section of the guide channel 23 is beneficial to the microinjection of the liquid. Referring to FIG. 4, the upper guide section 231 and the lower guide section 232 of the guide channel 23 can also be connected with a pressurized section 233. The diameter of the pressurized section 233 is less than or equal to the minimum diameter of the lower guide section 232. The design of the pressurized section 233 can not only accurately control the injection of liquid in minute amounts, but also further enhance the pressurizing effect to increase the flow rate of the liquid to be detected in the guide channel 23.

After the detection is completed, the connector module 3 will be separated from the biochip 2. When each liquid outlet joints 311 of the connector module 3 is detached from the corresponding connection opening 25, the connection opening 25 is elastic and can return to its original unexpanded state. Therefore, the connection opening 25 has a constricting effect on the liquid to be detected remaining on the liquid outlet joint 311 during the recovery process, which can reduce splashing during detachment and retain the residual liquid in the connection opening 25, to prevent residual liquid from being sprayed into adjacent liquid inlet 211 of the chip unit 21 and affecting the accuracy of detection.

To sum up, the elastic pad 22 of the biochip 2 is formed with the guide channels 23. By utilizing the tapered section in the guide channels 23, the injection amount can be accurately and minutely pushed. As the liquid outlet joints 311 of the connector module 3 are respectively connected to the upper guide sections 231 of the guide channels 23 of the elastic pad 22, it can not only avoid liquid leakage, but also possess a larger alignment tolerance, so as to solve the docking problem of movable parts during the dynamic liquid injection process, and to reduce the demand for the alignment precision between movable parts. Furthermore, the diameter of the upper guide section 231 of the guide channel 23 gradually shrinks from top to bottom, when the detection liquid enters the guide channel 23, it can enter the chip unit 21 more quickly to improve detection efficiency and accuracy, and to achieve high-throughput detection of biochip 2.

In addition, the design of the connection openings 25 of the elastic pad 22 also provides a covering effect when docked with the connector module 3 and a constricting effect when detached, ensuring that the liquid to be detected is not easy to leak or splash. Furthermore, the infusion tubes 321 of the connector module 3 is changed to a horizontal arrangement, which is different from the vertical direction of the photography system to save the space occupied by the liquid injection system and to avoid mutual interference during the detection process.

In recent years, due to the new coronavirus pneumonia, medical detection systems have become popular. However, since the conventional diversion modules can detect a limited number at one time, a long detection time is required when a large number of specimens need to be detected. The connector module 3 and the biochip 2 of the present invention are designed with multiplex detection flow guide modules, which can inject one or several detection liquids or reagents at the same time, greatly reducing the detection time. In addition, the present invention also integrates the connector module 3 and the biochip 2 into the same device, so that the terminal product can meet the detection requirements in a small space. This can significantly reduce the size of the terminal system and reduce the demand of the alignment precision, so as to increase the possibility of commercializing the terminal system.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A biochip, comprising:
a chip unit, including a plurality of liquid inlets arranged at intervals, and a plurality of microfluidic channels respectively connected to the liquid inlets; and
an elastic pad, including an upper surface and a lower surface, wherein the lower surface is attached to the chip unit, the elastic pad further includes a plurality of guide channels arranged at intervals and penetrating the upper surface and the lower surface of the elastic pad, the guide channels respectively correspond to the liquid inlets of the chip unit, and each of the guide channels includes an upper guide section, and the diameter of the upper guide section is gradually reduced from top to bottom.

2. The biochip as claimed in claim 1, wherein each of the guide channels further includes a lower guide section connected to the upper guide section, and the diameter of the lower guide section gradually increases from top to bottom.

3. The biochip as claimed in claim 2, wherein the lower guide section of each of the guide channels corresponds to one of the liquid inlets of the chip unit, and the diameter of the outlet of the lower guide section is larger than the diameter of the liquid inlet of the chip unit.

4. The biochip as claimed in claim 2, wherein the elastic pad further includes a pad body and a plurality of connection openings protruding from the pad body at intervals, the upper guide section of each of the guide channels extends from the corresponding connection opening toward the pad body, and the lower guide section of each of the guide channels is in the pad body.

5. The biochip as claimed in claim 2, wherein the upper guide section and the lower guide section of each of the guide channels are connected with a pressurized section, and the diameter of the pressurized section is less than or equal to the minimum diameter of the lower guide section.

6. A connector module, used in conjunction with the biochip as described in claim 1, the connector module comprising:
a fixed unit, including a plurality of liquid outlet joints arranged at intervals, and the liquid outlet joints are respectively connected with the upper guide sections of the guide channels of the elastic pad; and
an infusion unit, including a plurality of infusion tubes respectively connected to the liquid outlet joints.

7. The connector module as claimed in claim 6, wherein each of the liquid outlet joints protrudes from the bottom surface of the fixed unit, the fixed unit further includes a plurality of flow channels, each of the flow channels includes a vertical section, the vertical sections extend into the corresponding liquid outlet joints, and the infusion tubes of the infusion unit are respectively connected with the flow channels.

8. The connector module as claimed in claim 6, wherein each of the liquid outlet joint protrudes from the bottom surface of the fixed unit, the fixed unit further includes a plurality of flow channels, each of the flow channels includes a vertical section and a horizontal section connected to the vertical section, the vertical sections extend into the corresponding liquid outlet joints, and the infusion tubes of the infusion unit are respectively accommodated in corresponding horizontal sections and are respectively connected with the flow channels.

9. The connector module as claimed in claim 8, wherein the fixed unit further includes an upper fixed plate and a lower fixed plate, the upper surface of the lower fixed plate forms the flow channels, and the infusion tubes are clamped and positioned between the upper fixed plate and the lower fixed plate.

10. The connector module as claimed in claim 9, wherein each of the flow channels further includes a positioning section connected to the horizontal section, the width of the positioning section is greater than the width of the horizontal section, the infusion unit further includes a plurality of positioning members respectively accommodated in the positioning sections, and the infusion tubes are respectively clamped and positioned on corresponding positioning members and stretched into corresponding horizontal sections.

11. The connector module as claimed in claim 6, wherein the outer contour of each of the liquid outlet joints of the fixed unit matches the inner contour of the upper guide section of each of the guide channels.
